(19) United States
(12) Patent Application Publication
(10) Pub. No.: US 2026/0095953 A1
(43) Pub. Date: Apr. 2, 2026

(54) APPARATUS AND METHOD FOR DOWNLINK COVERAGE ENHANCEMENT IN COMMUNICATION NETWORK

(71) Applicant: ELECTRONICS AND TELECOMMUNICATIONS RESEARCH INSTITUTE, Daejeon (KR)

(72) Inventors: Gyeongrae IM, Daejeon (KR); Jung-Bin KIM, Daejeon (KR); Pansoo KIM, Daejeon (KR); Hee Wook KIM, Daejeon (KR); Dong Hyun JUNG, Daejeon (KR)

(21) Appl. No.: 19/270,162

(22) Filed: Jul. 15, 2025

(30) Foreign Application Priority Data
Jul. 16, 2024 (KR) 10-2024-0093865
Feb. 7, 2025 (KR) 10-2025-0016202
Mar. 28, 2025 (KR) 10-2025-0040604
May 9, 2025 (KR) 10-2025-0060512
Jul. 15, 2025 (KR) 10-2025-0095034

(51) Int. Cl. H04W 74/0833; H04W 72/232

(52) U.S. Cl. CPC H04W 74/0833; H04W 72/232

(57) ABSTRACT

Disclosed are an apparatus and a method for downlink coverage enhancement in a communication network. A method of a terminal according to an exemplary embodiment may comprise: receiving repeated transmission configuration information for a message 4 (Msg4) from a base station; and receiving the Msg4 from the base station in a random access (RA) procedure between the terminal and the base station, the receiving comprising performing repeated reception of the Msg4 based on the repeated transmission configuration information.

### CLAIM FOR PRIORITY

This application claims priority to Korean Patent Applications No. 10-2024-0093865, filed on Jul. 16, 2024, No. 10-2025-0016202, filed on Feb. 7, 2025, No. 10-2025-0040604, filed on Mar. 28, 2025, No. 10-2025-0060512, filed on May 9, 2025, and No. 10-2025-0095034, filed on Jul. 15, 2025, with the Korean Intellectual Property Office (KIPO), the entire contents of which are hereby incorporated by reference.

### BACKGROUND

### Technical Field

The present disclosure relates to an apparatus and a method for downlink coverage enhancement in a communication network. For example, the present disclosure relates to a configuration and procedure for a signal transmission technique that improves a link budget in downlink transmission, for downlink coverage enhancement in a wireless communication system.

### Related Art

In wireless communication systems, the fifth-generation mobile communication technology, New Radio (NR), has excellent performance in conventional terrestrial networks. However, in satellite communication environments such as Non-Terrestrial Network (NTN), significant signal propagation loss and extremely low received Signal-to-Noise Ratio (SNR) occur, resulting in difficulties in achieving a required coverage using the existing 3rd Generation Partnership Project (3GPP) standard technologies.

The 3GPP has conducted studies on NR coverage enhancement up to Release 17 and identified physical channels that cause major bottlenecks. In a Frequency Range 1 (FR1) band, channels identified as requiring improvement include a Physical Uplink Shared Channel (PUSCH) for Enhanced Mobile Broadband (eMBB), a PUSCH for Voice over Internet Protocol (VoIP), a Physical Random Access Channel (PRACH) format B4, a PUSCH for Msg3, Physical Uplink Control Channel (PUCCH) formats 1 and 3, and a broadcast Physical Downlink Control Channel (PDCCH). Most of these are uplink channels, and key techniques proposed for coverage enhancement include increasing the number of repeated transmissions, TB processing over multi-slot (TBoMS) PUSCH, joint channel estimation, and Demodulation Reference Signal (DM-RS) bundling.

In particular, for a PUSCH repetition type A technique, the maximum number of repeated transmissions has been increased from 16 to 32, and in Time Division Duplex (TDD) environments, a mechanism has been standardized whereby invalid slots, depending on a slot pattern, are not counted as repeated transmissions. Additionally, in Release 17, a coverage enhancement technique using uplink repeated transmission of Msg3 during an initial access procedure has been introduced, and performance improvements of approximately 2 dB in FR1 with two repetitions and more than 4 dB in FR2 with eight repetitions have been observed.

In Release 18, studies have been conducted on uplink coverage enhancement in NR-NTN environments, with an uplink Hybrid Automatic Repeat Request (HARQ) signal for Msg4 identified as the top priority for improvement. Accordingly, a procedure for repeated transmission of HARQ-ACK for Msg4 has been defined, but this is limited to uplink signals only.

In satellite communication systems, standardization bodies such as the International Telecommunication Union (ITU) recommend output power restrictions to prevent interference with terrestrial systems. These restrictions are intended to protect other mobile communication services operating in the same frequency bands, and an Effective Isotropic Radiated Power (EIRP) is limited based on a Power Flux Density (PFD) received on the ground from satellite transmissions. When this regulation is applied to 3GPP NR-NTN, it becomes difficult to achieve a sufficient link budget for many downlink channels.

The existing NR initial access procedure may be configured as a four-step Random Access Channel (RACH) procedure. After acquiring a Master Information Block (MIB) and Remaining Minimum System Information (RMSI) from a Synchronization Signal Block (SSB), a terminal reads RACH occasion information from a System Information Block Type 1 (SIB1) and transmits a Msg1 preamble based thereon. In response, a base station transmits Msg2, a Random Access Response (RAR), and the terminal transmits Msg3 to deliver its identity information. Finally, the base station transmits Msg4, a Contention Resolution message, through a Physical Downlink Shared Channel (PDSCH).

Currently, under the 3GPP NR specifications, Msg4 is only supported as a single transmission, and no repeated transmission mechanism is provided. Msg4 is structured as a Downlink (DL) Common Control Channel (CCCH) Protocol Data Unit (PDU) and is a critical message for determining the success of the terminal's initial access. However, in harsh channel environments such as NTN, failure to receive Msg4 may lead to failure of the entire initial access procedure. This is especially problematic when the terminal is not yet in a Radio Resource Control (RRC) connected state with the base station, available time and frequency resources are limited, making it even more difficult to improve signal quality.

The technology underlying the present disclosure is disclosed in U.S. Patent Application Publication No. 2023/0354410.

### SUMMARY

The present disclosure is intended to solve the above-described problems of the related art, and aims to provide an apparatus and a method for improving downlink coverage in a communication network, which are capable of implementing a repeated Msg4 transmission function in order to extend downlink coverage in a wireless communication system having insufficient link budget due to output power restrictions, such as in a non-terrestrial network (NTN) environment, thereby improving an initial access success rate of a terminal.

The present disclosure is intended to solve the above-described problems of the related art, and aims to provide an apparatus and a method for improving downlink coverage in a communication network, which enable stable initial access even in an environment where a channel state is poor or signal loss is large, by improving reception quality of a downlink signal transmitted by a base station when a terminal is not yet connected to the base station.

However, the technical problems to be achieved by exemplary embodiments of the present disclosure are not limited to the technical problems described above, and other technical problems may exist.

As a technical means for solving the above-described technical problem, a method of a terminal according to an exemplary embodiment of the present disclosure may comprise: receiving repeated transmission configuration information for a message 4 (Msg4) from a base station; and receiving the Msg4 from the base station in a random access (RA) procedure between the terminal and the base station, the receiving comprising performing repeated reception of the Msg4 based on the repeated transmission configuration information.

The repeated transmission configuration information may include information on a repetition factor commonly applied to a plurality of terminals associated with a cell corresponding to the base station.

The repeated transmission configuration information may include information on a repetition factor dynamically allocated for each of the plurality of terminals.

The method may further comprise transmitting, to the base station, at least one of: a request indicating that repeated transmission of the Msg4 is required, or information on a repeated reception capability of the terminal.

The transmitting may comprise transmitting at least one of the request or the information on the repeated reception capability using a Msg3.

The transmitting may comprise transmitting a MAC control element (CE) including at least one of the request or the information on the repeated reception capability, when transmitting the Msg3.

The transmitting may comprise selecting a random access channel (RACH) occasion (RO) for transmitting at least one of the request or the information on the repeated reception capability in Msg1 transmission.

The repeated reception of the Msg4 may be performed in consideration of at least one of whether repeated transmission is applied to a predetermined downlink channel or a repetition factor applied to the predetermined downlink channel.

The receiving of the repeated transmission configuration information may comprise receiving the repeated transmission configuration information including information on repetition factor(s) through system information (SI).

The repeated transmission configuration information may include a quality threshold for determining whether repeated transmission of the Msg4 is required.

The performing of the repeated reception may comprise applying the repeated reception of the Msg4, when a quality evaluation value measured at the terminal is lower than the quality threshold.

The repeated transmission configuration information may include information on supported repetition factors.

Information on a repetition factor among the supported repetition factors may be indicated in a field of downlink control information (DCI).

The supported repetition factors may include 2 or 4.

The performing of the repeated reception of the Msg4 may comprise receiving the Msg4 in a plurality of consecutive slots with a same resource allocation, different redundancy versions (RVs) or RVs that are at least partially identical being applied to repetitions of the Msg4.

Meanwhile, a method of a base station according to an example embodiment of the present disclosure may comprise: transmitting repeated transmission configuration information for a message4 (Msg4) to a terminal; and transmitting the Msg4 to the terminal in a random access (RA) procedure between the terminal and the base station, the transmitting comprising performing repeated transmission of the Msg4 based on the repeated transmission configuration information.

The method may further comprise receiving, from the terminal, at least one of: a request indicating that repeated transmission of the Msg4 is required, or information on a repeated reception capability of the terminal.

The receiving may comprise receiving at least one of the request or the information on the repeated reception capability using a Msg3.

The receiving may comprise receiving a MAC CE including at least one of the request or the information on the repeated reception capability, when receiving the Msg3.

The receiving may comprise receiving the at least one of the request or the information on the repeated reception capability through a random access channel (RACH) occasion (RO) selected for transmission of the at least one of the request or the information on the repeated reception capability.

The transmitting of the repeated transmission configuration information may comprise transmitting the repeated transmission configuration information including information on repetition factor(s) through system information (SI).

The performing of the repeated transmission may comprise applying the repeated transmission of the Msg4, when a quality evaluation value measured at the terminal is lower than the quality threshold.

The performing of the repeated transmission of the Msg4 comprises: transmitting the Msg4 in a plurality of consecutive slots with a same resource allocation, different redundancy versions (RVs) or RVs that are at least partially identical being applied to repetitions of the Msg4.

Meanwhile, a terminal according to an exemplary embodiment of the present disclosure may comprise at least one processor, and the at least one processor may cause the terminal to perform: receiving repeated transmission configuration information for a message 4 (Msg4) from a base station; and receiving the Msg4 from the base station in a random access (RA) procedure between the terminal and the base station, the receiving comprising performing repeated reception of the Msg4 based on the repeated transmission configuration information.

The repeated transmission configuration information may include at least one of: information on a repetition factor commonly applied to a plurality of terminals associated with a cell corresponding to the base station, or information on a repetition factor dynamically allocated for each of the plurality of terminals.

The at least one processor may further cause the terminal to perform: transmitting, to the base station, at least one of: a request indicating that repeated transmission of the Msg4 is required, or information on a repeated reception capability of the terminal.

In the performing of the repeated reception of the Msg4, the at least one processor may further cause the terminal to perform: receiving the Msg4 in a plurality of consecutive slots with a same resource allocation, different redundancy versions (RVs) or RVs that are at least partially identical being applied to repetitions of the Msg4.

Meanwhile, a base station according to an exemplary embodiment of the present disclosure may comprise at least one processor, and the at least one processor may cause the base station to perform: transmitting repeated transmission configuration information for a message4 (Msg4) to a terminal; and transmitting the Msg4 to the terminal in a random access (RA) procedure between the terminal and the base station, the transmitting comprising performing repeated transmission of the Msg4 based on the repeated transmission configuration information.

The problem-solving means described above are merely exemplary and should not be construed as intending to limit the present disclosure. In addition to the above-described exemplary embodiment, additional exemplary embodiments may exist in the drawings and the detailed description of the present disclosure.

According to the problem-solving means of the present disclosure described above, in a wireless communication system in which a link budget is insufficient due to output power restrictions such as in a Non-Terrestrial Network (NTN) environment, an apparatus and a method for downlink coverage enhancement in a communication network can be provided by implementing a repeated Msg4 transmission function to improve a success rate of initial access by a terminal.

According to the problem-solving means of the present disclosure described above, an apparatus and a method for downlink coverage enhancement in a communication network can be provided to enable stable initial access even in environments with poor channel conditions or significant signal loss, by improving the reception quality of a downlink signal transmitted by a base station when a terminal is not yet connected to the base station.

According to the problem-solving means of the present disclosure described above, repeated transmission of a downlink signal to a terminal not yet connected becomes possible, thereby improving a reception SNR at the terminal in a wireless communication environment with poor channel conditions or significant loss, and achieving a signal combining gain through repeated Msg4 transmission, which may significantly expand downlink coverage in an NTN environment.

According to the problem-solving means of the present disclosure described above, by providing repeated transmission configuration in both a cell-common manner and a terminal-specific dynamic manner, it is possible to efficiently respond to various channel environments and terminal distributions.

According to the problem-solving means of the present disclosure described above, through a conditional repeated transmission mechanism based on a quality threshold such as an RSRP threshold, it is possible to support efficient use of radio resources by applying repeated transmission only to necessary terminals.

According to the problem-solving means of the present disclosure described above, flexibility in system implementation can be secured by providing various signaling methods such as reuse of existing DCI fields, MAC CE, and RO partitioning.

According to the problem-solving means of the present disclosure described above, diversity gain can be obtained through cyclic application of RV in consecutive slots, thereby maximizing the efficiency of repeated transmission.

However, the effects obtainable from the present disclosure are not limited to the effects described above, and other effects may also be present.

### BRIEF DESCRIPTION OF DRAWINGS

FIG. 1 is a block diagram illustrating a first exemplary embodiment of a communication node in a communication network.

FIG. 2 is a conceptual diagram illustrating a first exemplary embodiment of a communication network.

FIG. 3 is a conceptual diagram illustrating a second exemplary embodiment of a communication network.

FIG. 4 is a conceptual diagram illustrating a third exemplary embodiment of a communication network.

FIG. 5 is a diagram illustrating a contention-based random access (RACH) four-step procedure in an NR system.

FIG. 6 is a diagram illustrating a structure of the RAR message and functions of respective fields of the RAR message.

FIG. 7 is a diagram illustrating a structure of a downlink common control channel (DL CCCH) protocol data unit (PDU) of Msg4.

FIGS. 8A to 8C are conceptual diagrams for illustratively describing a method of indicating a Msg4 repetition factor using DCI field(s).

### DESCRIPTION OF EXEMPLARY EMBODIMENTS OF THE PRESENT DISCLOSURE

Hereinafter, exemplary embodiments of the present disclosure will be described in detail with reference to the accompanying drawings so that those skilled in the art can easily implement the present disclosure. However, the present disclosure may be implemented in various different forms and is not limited to the exemplary embodiments described herein. In addition, in order to clearly describe the present disclosure in the drawings, parts irrelevant to the description have been omitted, and like reference numerals are assigned to like elements throughout the entire specification.

Throughout the entire specification of the present disclosure, when one part is described as being “connected” to another part, this includes not only a case where the parts are “directly connected” but also a case where the parts are “electrically connected” or “indirectly connected” with another element interposed therebetween.

Throughout the entire specification of the present disclosure, when one member is described as being “on,” “above,” or “at an upper portion” or “under,” “below,” or “at a lower portion” of another member, this includes not only a case where the one member is in contact with the other member but also a case where another member exists between the two members.

Throughout the entire specification of the present disclosure, when a part is described as “including” a certain component, this means that the part may further include other components as long as there is no explicit description to the contrary, and does not exclude the presence of other components.

The present disclosure relates to a device and method for improving downlink coverage in a communication network. For example, the present disclosure relates to a configuration and procedure of a signal transmission scheme for improving a link budget in downlink transmission to expand downlink coverage in a wireless communication system.

Hereinafter, preferred exemplary embodiments of the present disclosure will be described in more detail with reference to the accompanying drawings. In describing the present disclosure, to facilitate an overall understanding, the same reference numerals are used for the same components in the drawings, and redundant descriptions of the same components are omitted.

A communication system to which exemplary embodiments according to the present disclosure are applied will be described. The communication system may be the 4G communication system (e.g. Long-Term Evolution (LTE) communication system or LTE-A communication system), the 5G communication system (e.g. New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication network may include a terrestrial network and a non-terrestrial network. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In other words, “an operation (e.g. transmission operation) is configured in a communication node” may mean that the communication node receives “configuration information (e.g. information elements, parameters) for the operation” and/or “information indicating to perform the operation”. “An information element (e.g. parameter) is configured in a communication node” may mean that “the information element is signaled to the communication node (e.g. the communication node receives the information element)”.

The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)). A signaling message may be at least one of an SI signaling message (e.g. SI message), an RRC signaling message (e.g. RRC message), a MAC CE signaling message (e.g. MAC CE message or MAC message), or a PHY signaling message (e.g. PHY message).

Hereinafter, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

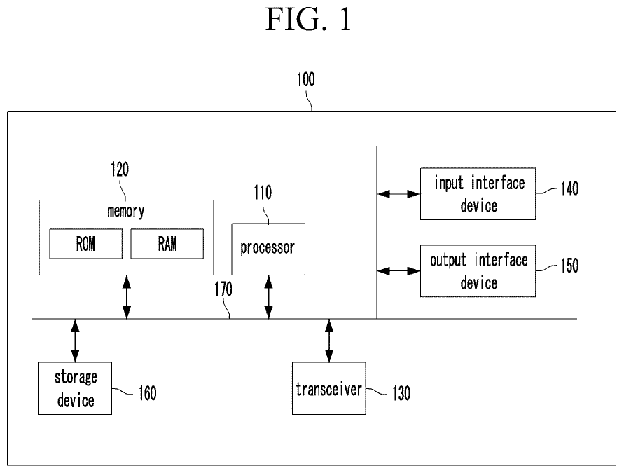

FIG. 1 is a block diagram illustrating a first exemplary embodiment of a communication node in a communication network.

Referring to FIG. 1, a communication 100 may perform communication in a communication network. The communication node 100 may comprise at least one processor 110, a memory 120, and a transceiver 130 connected to the network for performing communications. Also, the communication node 100 may further comprise an input interface device 140, an output interface device 150, a storage device 160, and the like. Each component included in the communication node 100 may communicate with each other as connected through a bus 170.

However, each component included in the communication node 100 may not be connected to the common bus 170 but may be connected to the processor 110 via an individual interface or a separate bus. For example, the processor 110 may be connected to at least one of the memory 120, the transceiver 130, the input interface device 140, the output interface device 150 and the storage device 160 via a dedicated interface.

The processor 110 may execute a program stored in at least one of the memory 120 and the storage device 160. The processor 110 may refer to a central processing unit (CPU), a graphics processing unit (GPU), or a dedicated processor on which methods in accordance with embodiments of the present disclosure are performed. Each of the memory 120 and the storage device 160 may be constituted by at least one of a volatile storage medium and a non-volatile storage medium. For example, the memory 120 may comprise at least one of read-only memory (ROM) and random access memory (RAM).

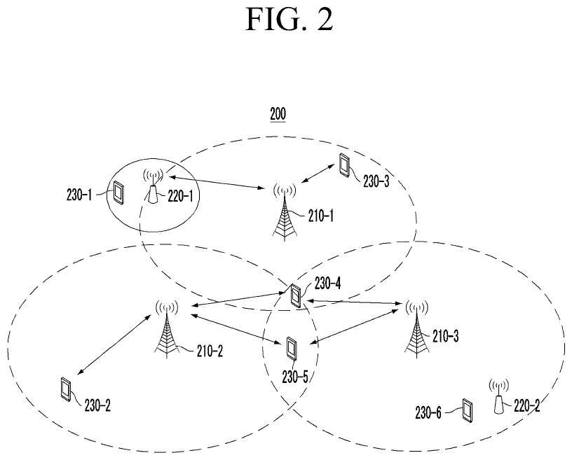

FIG. 2 is a conceptual diagram illustrating a first exemplary embodiment of a communication network.

Referring to FIG. 2, a communication network 200 may be a terrestrial network. The communication system 200 may comprise a plurality of communication nodes 210-1, 210-2, 210-3, 220-1, 220-2, 230-1, 230-2, 230-3, 230-4, 230-5, and 230-6. In addition, the communication system 200 may further comprise a core network (e.g. a serving gateway (S-GW), a packet data network (PDN) gateway (P-GW), and a mobility management entity (MME)). When the communication system 200 is a 5G communication system (e.g. new radio (NR) system), the core network may include an access and mobility management function (AMF), a user plane function (UPF), a session management function (SMF), and the like.

The plurality of communication nodes 210 to 230 may support a communication protocol defined by the 3rd generation partnership project (3GPP) specifications (e.g. LTE communication protocol, LTE-A communication protocol, NR communication protocol, or the like). The plurality of communication nodes 210 to 230 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like. Each of the plurality of communication nodes may have the following structure.

The communication system 200 may comprise a plurality of base stations 210-1, 210-2, 210-3, 220-1, and 220-2, and a plurality of terminals 230-1, 230-2, 230-3, 230-4, 230-5, and 230-6. Each of the first base station 210-1, the second base station 210-2, and the third base station 210-3 may form a macro cell, and each of the fourth base station 220-1 and the fifth base station 220-2 may form a small cell. The fourth base station 220-1, the third terminal 230-3, and the fourth terminal 230-4 may belong to cell coverage of the first base station 210-1. Also, the second terminal 230-2, the fourth terminal 230-4, and the fifth terminal 230-5 may belong to cell coverage of the second base station 210-2. Also, the fifth base station 220-2, the fourth terminal 230-4, the fifth terminal 230-5, and the sixth terminal 230-6 may belong to cell coverage of the third base station 210-3. Also, the first terminal 230-1 may belong to cell coverage of the fourth base station 220-1, and the sixth terminal 230-6 may belong to cell coverage of the fifth base station 220-2.

Here, each of the plurality of base stations 210-1, 210-2, 210-3, 220-1, and 220-2 may refer to a Node-B (NB), a evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

Each of the plurality of terminals 230-1, 230-2, 230-3, 230-4, 230-5, and 230-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on-board unit (OBU), or the like.

Each of the plurality of base stations 210-1, 210-2, 210-3, 220-1, and 220-2 may operate in the same frequency band or in different frequency bands. The plurality of base stations 210-1, 210-2, 210-3, 220-1, and 220-2 may be connected to each other via an ideal backhaul or a non-ideal backhaul, and exchange information with each other via the ideal or non-ideal backhaul. Also, each of the plurality of base stations 210-1, 210-2, 210-3, 220-1, and 220-2 may be connected to the core network through the ideal or non-ideal backhaul. Each of the plurality of base stations 210-1, 210-2, 210-3, 220-1, and 220-2 may transmit a signal received from the core network to the corresponding terminal 230-1, 230-2, 230-3, 230-4, 230-5, or 230-6, and transmit a signal received from the corresponding terminal 230-1, 230-2, 230-3, 230-4, 230-5, or 230-6 to the core network.

In addition, each of the plurality of base stations 210-1, 210-2, 210-3, 220-1, and 220-2 may support a multi-input multi-output (MIMO) transmission (e.g. a single-user MIMO (SU-MIMO), a multi-user MIMO (MU-MIMO), a massive MIMO, or the like), a coordinated multipoint (COMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 230-1, 230-2, 230-3, 230-4, 230-5, and 230-6 may perform operations corresponding to the operations of the plurality of base stations 210-1, 210-2, 210-3, 220-1, and 220-2 (i.e. the operations supported by the plurality of base stations 210-1, 210-2, 210-3, 220-1, and 220-2). For example, the second base station 210-2 may transmit a signal to the fourth terminal 230-4 in the SU-MIMO manner, and the fourth terminal 230-4 may receive the signal from the second base station 210-2 in the SU-MIMO manner. Alternatively, the second base station 210-2 may transmit a signal to the fourth terminal 230-4 and fifth terminal 230-5 in the MU-MIMO manner, and the fourth terminal 230-4 and fifth terminal 230-5 may receive the signal from the second base station 210-2 in the MU-MIMO manner.

The first base station 210-1, the second base station 210-2, and the third base station 210-3 may transmit a signal to the fourth terminal 230-4 in the COMP transmission manner, and the fourth terminal 230-4 may receive the signal from the first base station 210-1, the second base station 210-2, and the third base station 210-3 in the COMP manner. Also, each of the plurality of base stations 210-1, 210-2, 210-3, 220-1, and 220-2 may exchange signals with the corresponding terminals 230-1, 230-2, 230-3, 230-4, 230-5, or 230-6 which belongs to its cell coverage in the CA manner. Each of the base stations 210-1, 210-2, and 210-3 may control D2D communications between the fourth terminal 230-4 and the fifth terminal 230-5, and thus the fourth terminal 230-4 and the fifth terminal 230-5 may perform the D2D communications under control of the second base station 210-2 and the third base station 210-3.

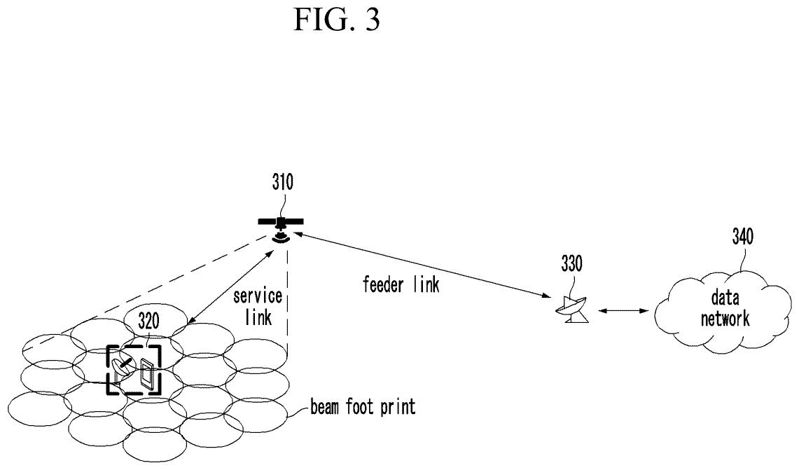

FIG. 3 is a conceptual diagram illustrating a second exemplary embodiment of a communication network.

Referring to FIG. 3, a communication network may be a non-terrestrial network (NTN). The NTN may include a satellite 310, a communication node 320, a gateway 330, a data network 340, and the like. The NTN shown in FIG. 3 may be an NTN based on a transparent payload. The satellite 310 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 320 may include a communication node (e.g. a user equipment (UE) or a terminal) located on a terrestrial site and a communication node (e.g. an airplane, a drone) located on a non-terrestrial space. A service link may be established between the satellite 310 and the communication node 320, and the service link may be a radio link. The satellite 310 may provide communication services to the communication node 320 using one or more beams. The shape of a footprint of the beam of the satellite 310 may be elliptical.

The communication node 320 may perform communications (e.g. downlink communication and uplink communication) with the satellite 310 using LTE technology and/or NR technology. The communications between the satellite 310 and the communication node 320 may be performed using an NR-Uu interface. When dual connectivity (DC) is supported, the communication node 320 may be connected to other base stations (e.g. base stations supporting LTE and/or NR functionality) as well as the satellite 310, and perform DC operations based on the techniques defined in the LTE and/or NR specifications.

The gateway 330 may be located on a terrestrial site, and a feeder link may be established between the satellite 310 and the gateway 330. The feeder link may be a radio link. The gateway 330 may be referred to as a ‘non-terrestrial network (NTN) gateway’. The communications between the satellite 310 and the gateway 330 may be performed based on an NR-Uu interface or a satellite radio interface (SRI). The gateway 330 may be connected to the data network 340. There may be a ‘core network’ between the gateway 330 and the data network 340. In this case, the gateway 330 may be connected to the core network, and the core network may be connected to the data network 340. The core network may support the NR technology. For example, the core network may include an access and mobility management function (AMF), a user plane function (UPF), a session management function (SMF), and the like. The communications between the gateway 330 and the core network may be performed based on an NG-C/U interface.

Alternatively, a base station and the core network may exist between the gateway 330 and the data network 340. In this case, the gateway 330 may be connected with the base station, the base station may be connected with the core network, and the core network may be connected with the data network 340. The base station and core network may support the NR technology. The communications between the gateway 330 and the base station may be performed based on an NR-Uu interface, and the communications between the base station and the core network (e.g. AMF, UPF, SMF, and the like) may be performed based on an NG-C/U interface.

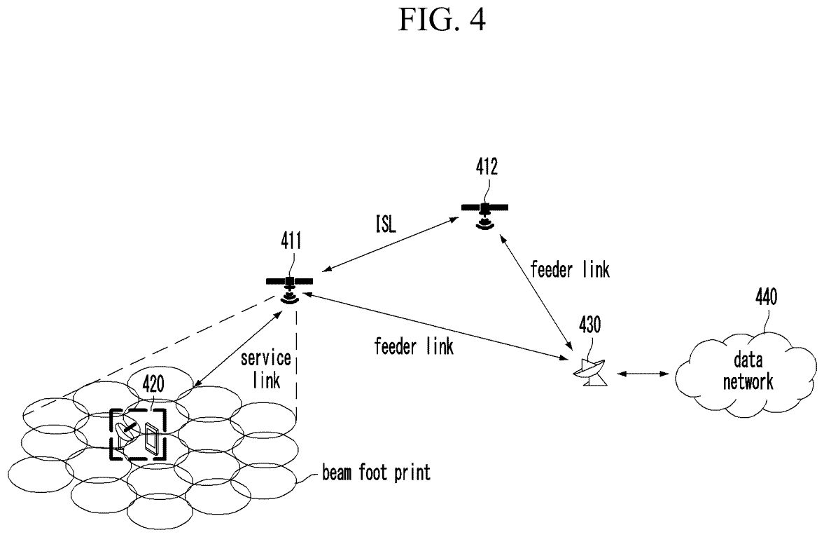

FIG. 4 is a conceptual diagram illustrating a third exemplary embodiment of a communication network.

Referring to FIG. 4, a communication network may be an NTN. The NTN may include a first satellite 411, a second satellite 412, a communication node 420, a gateway 430, a data network 440, and the like. The NTN shown in FIG. 4 may be a regenerative payload based NTN. For example, each of the satellites 411 and 412 may perform a regenerative operation (e.g. demodulation, decoding, re-encoding, re-modulation, and/or filtering operation) on a payload received from other entities (e.g. the communication node 420 or the gateway 430), and transmit the regenerated payload.

Each of the satellites 411 and 412 may be a LEO satellite, a MEO satellite, a GEO satellite, a HEO satellite, or a UAS platform. The UAS platform may include a HAPS. The satellite 411 may be connected to the satellite 412, and an inter-satellite link (ISL) may be established between the satellite 411 and the satellite 412. The ISL may operate in an RF frequency band or an optical band. The ISL may be established optionally. The communication node 420 may include a terrestrial communication node (e.g. UE or terminal) and a non-terrestrial communication node (e.g. airplane or drone). A service link (e.g. radio link) may be established between the satellite 411 and communication node 420. The satellite 411 may provide communication services to the communication node 420 using one or more beams.

The communication node 420 may perform communications (e.g. downlink communication or uplink communication) with the satellite 411 using LTE technology and/or NR technology. The communications between the satellite 411 and the communication node 420 may be performed using an NR-Uu interface. When DC is supported, the communication node 420 may be connected to other base stations (e.g. base stations supporting LTE and/or NR functionality) as well as the satellite 411, and may perform DC operations based on the techniques defined in the LTE and/or NR specifications. The gateway 430 may be located on a terrestrial site, a feeder link may be established between the satellite 411 and the gateway 430, and a feeder link may be established between the satellite 412 and the gateway 430. The feeder link may be a radio link. When the ISL is not established between the satellite 411 and the satellite 412, the feeder link between the satellite 411 and the gateway 430 may be established mandatorily.

The communications between each of the satellites 411 and 412 and the gateway 430 may be performed based on an NR-Uu interface or an SRI. The gateway 430 may be connected to the data network 440. There may be a core network between the gateway 430 and the data network 440. In this case, the gateway 430 may be connected to the core network, and the core network may be connected to the data network 440. The core network may support the NR technology. For example, the core network may include AMF, UPF, SMF, and the like. The communications between the gateway 430 and the core network may be performed based on an NG-C/U interface.

Alternatively, a base station and the core network may exist between the gateway 430 and the data network 440. In this case, the gateway 430 may be connected with the base station, the base station may be connected with the core network, and the core network may be connected with the data network 440. The base station and the core network may support the NR technology. The communications between the gateway 430 and the base station may be performed based on an NR-Uu interface, and the communications between the base station and the core network (e.g. AMF, UPF, SMF, and the like) may be performed based on an NG-C/U interface.

NTN reference scenarios may be defined as shown in Table 1 below.

TABLE 1

| | NTN shown in FIG. 3 | NTN shown in FIG. 4 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 310 in the NTN shown in FIG. 3 is a GEO satellite (e.g. a GEO satellite that supports a transparent function), this may be referred to as ‘scenario A’. When the satellites 411 and 412 in the NTN shown in FIG. 4 are GEO satellites (e.g. GEOs that support a regenerative function), this may be referred to as ‘scenario B’.

When the satellite 310 in the NTN shown in FIG. 3 is an LEO satellite with steerable beams, this may be referred to as ‘scenario C1’. When the satellite 310 in the NTN shown in FIG. 3 is an LEO satellite having beams moving with the satellite, this may be referred to as ‘scenario C2’. When the satellites 411 and 412 in the NTN shown in FIG. 4 are LEO satellites with steerable beams, this may be referred to as ‘scenario D1’. When the satellites 411 and 412 in the NTN shown in FIG. 4 are LEO satellites having beams moving with the satellites, this may be referred to as ‘scenario D2’.

Parameters for the scenarios defined in Table 1 may be defined as shown in Table 2 below.

TABLE 2

| | Scenarios A and B | | Scenarios C and D | |
|---|---|---|---|---|
| Altitude | 35,786 | km | 600 | km |

| | |
|---|---|
| 1,200 | km |

| Spectrum (service link) | <6 GHz (e.g. 2 GHz) | | |
|---|---|---|---|
| | >6 GHz (e.g. DL 20 GHz, UL 30 GHz) | | |
| Maximum channel | 30 MHz for band <6 GHz | | |
| bandwidth capability | 1 GHz for band >6 GHz | | |
| (service link) | | | |
| Maximum distance between | 40,581 | km | 1,932 km (altitude |
| satellite and communication | | | of 600 km) |
| node (e.g. UE) at the | | | 3,131 km (altitude |
| minimum elevation angle | | | of 1,200 km) |
| Maximum round trip delay | Scenario A: 541.46 ms | | Scenario C: |
| (RTD) | (service and feeder links) | | (transparent payload: |
| (only propagation delay) | Scenario B: 270.73 ms | | service and feeder links) |
| | (only service link) | | −5.77 ms (altitude |
| | | | of 60 0 km) |
| | | | −41.77 ms (altitude |
| | | | of 1,200 km) |
| | | | Scenario D: |
| | | | (regenerative payload: |
| | | | only service link) |
| | | | −12.89 ms (altitude |
| | | | of 600 km) |
| | | | −20.89 ms (altitude |
| | | | of 1,200 km) |
| Maximum differential delay | 10.3 | ms | 3.12 ms (altitude |
| within a cell | | | of 600 km) |

3.18 ms (altitude
of 1,200 km)

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | Scenario D1-2 |
|---|---|---|---|---|
| Satellite altitude | 35,786 km | | 600 km | |
| Maximum RTD in a | 541.75 ms | 270.57 ms | 28.41 ms | 12.88 ms |
| radio interface | (worst case) | | | |
| between base station | | | | |
| and UE | | | | |
| Minimum RTD in a | 477.14 ms | 238.57 ms | 8 ms | 4 ms |
| radio interface | | | | |
| between base station | | | | |
| and UE | | | | |

Meanwhile, a terminal may perform an initial access procedure with a base station. The initial access procedure may be classified into a four-step random access (RA) procedure and a two-step RA procedure. In the four-step RA procedure, the terminal may receive a message 4 (Msg4) from the base station and may transmit a hybrid automatic repeat request-acknowledgement (HARQ-ACK) for the Msg4 to the base station through a physical uplink control channel (PUCCH) or a physical uplink shared channel (PUSCH). The HARQ-ACK for the Msg4 may be referred to as a Msg4 HARQ-ACK. In the two-step RA procedure, the terminal may receive a message B (MsgB) from the base station and may transmit a HARQ-ACK for the MsgB to the base station through a PUCCH or a PUSCH. The HARQ-ACK for the MsgB may be referred to as a MsgB HARQ-ACK.

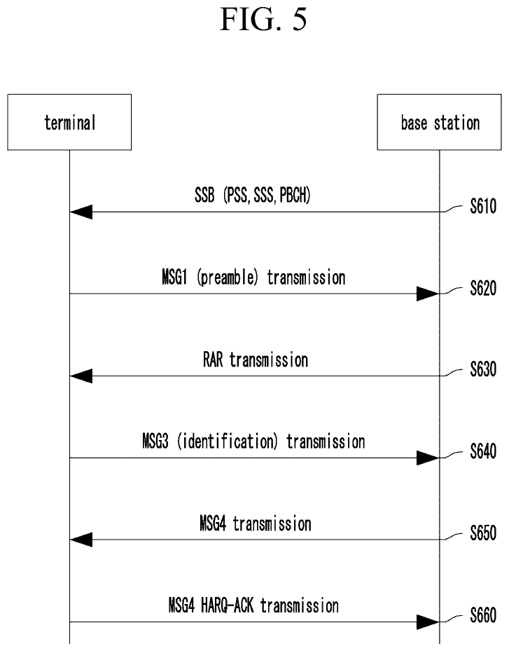

In this regard, FIG. 5 is a diagram illustrating a contention-based random access (RACH) four-step procedure in an NR system.

Hereinafter, with reference to FIG. 5, a procedure by which a terminal attempts to access a base station through a contention-based random access (RA) in a conventional terrestrial NR will be described.

The terminal attempting initial access may read a synchronization signal block (SSB) periodically transmitted from the base station in a synchronization raster, and may acquire and store basic configurations for a cell and signal transmission such as a master information block (MIB) and a remaining minimum system information (RMSI). Specifically, the terminal may acquire the MIB from the SSB, search for a system information block 1 (SIB1) based on a position of the SIB1 obtained from the MIB, acquire RACH occasion information from the SIB1, and transmit a preamble (Msg1) in a corresponding RACH occasion.

Subsequently, the base station receiving the Msg1 may calculate a random access-radio network temporary identifier (RA-RNTI), and transmit a message 2 (Msg2) (i.e. random access response (RAR)) configured as a MAC protocol data unit (PDU) by using the RA-RNTI.

In addition, the terminal that successfully receives the Msg2 may acquire information required for transmitting a Msg3 from timing advance (TA) information and uplink (UL) grant of the Msg2 and may transmit the Msg3. Upon receiving the Msg3, the base station may transmit a contention resolution message (i.e. Msg4) through a physical downlink shared channel (PDSCH). The terminal that successfully receives the Msg4 may transmit a HARQ feedback for the Msg4 to the base station.

Hereinafter, each of the messages (Msg1 through Msg4) associated with the contention-based four-step RA procedure will be described in detail.

First, in relation to the Msg1, the terminal attempting to initially access a network may obtain information for random access from the SIB1. A time and frequency resource for random access is referred to as a RACH occasion, and a designated time and frequency may be configured as a RACH occasion for each base station. The terminal arbitrarily configures a preamble sequence to be transmitted and generates the Msg1 signal using the preamble sequence. An NR preamble sequence is based on a Zadoff-Chu sequence. This is because the Zadoff-Chu-based sequence has many desirable properties, including constant envelope before and after discrete Fourier transform (DFT), high autocorrelation, and low cross-correlation.

Next, in relation to the Msg2, the base station may calculate the RA-RNTI based on a position of a resource corresponding to the RACH occasion in which the Msg1 has been transmitted. Specifically, when the base station detects the preamble in a specific RACH occasion, the base station transmits a DCI scrambled by the RA-RNTI corresponding to the RACH occasion and transmits a random access response (RAR). The terminal attempts to detect the DCI having the RA-RNTI corresponding to the RACH occasion in which the terminal has transmitted the preamble within a RAR window. The position where the detection is attempted may be referred to as a Type 1 PDCCH common search space.

A format of the DCI may be a DCI_1_0 scrambled by the RA-RNTI, and a resource allocation type for the Msg2 PDSCH may be a resource allocation configuration type 1.

For example, the length of the RAR window may be configured by an RRC parameter, rar-Window Length, configured in the SIB. If the terminal successfully decodes the DCI of the PDCCH and accurately obtains downlink allocation information, the terminal may decode a PDSCH carrying the RAR. After decoding the RAR, the terminal checks whether a random access preamble ID (RAPID) in the RAR matches a RAPID assigned to the terminal. The PDCCH and PDSCH need to be transmitted using the same subcarrier spacing and cyclic prefix as those of the SIB1.

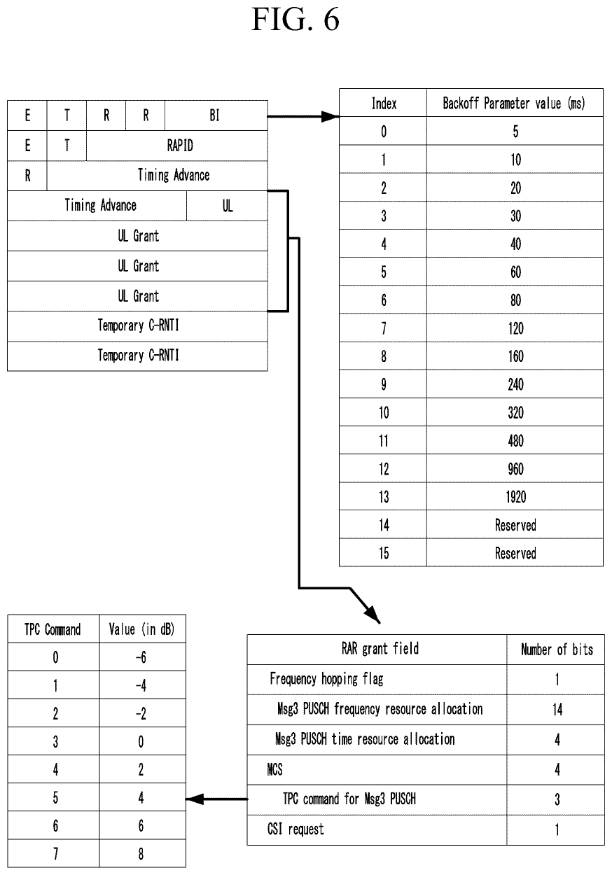

In this regard, FIG. 6 is a diagram illustrating a structure of the RAR message and functions of respective fields of the RAR message.

Next, in relation to the Msg3, after receiving the RAR, the terminal may transmit a message including identification information of the terminal (i.e. unique information for identifying the terminal, such as C-RNTI or common control channel (CCCH) information) as the Msg3. Specifically, the Msg3 includes information for contention resolution, and a terminal already having a C-RNTI transmits its C-RNTI, which may be determined from a logical channel ID (LCID) of a MAC CE. For example, a terminal intending to transmit a C-RNTI may transmit an LCID 58 and then transmit its C-RNTI. A terminal that does not have a C-RNTI may transmit identification information using a LCID 52 (CCCH of size 48 bits; if a terminal had previously accessed the core network, a temporary mobile subscriber identity (TMSI) is transmitted; otherwise, a 48-bit random sequence is transmitted).

Next, in relation to the Msg4, when the base station successfully receives the Msg3, the base station may include a contention resolution identity contained in the Msg3 in the Msg4 and transmit it to the terminal.

Meanwhile, when two or more terminals transmit Msg3, the following two cases may occur. First, if neither Msg3 is successfully received, the base station does not transmit a Msg4, and both terminals consider the initial access to have failed, discard a temporary C-RNTI (TC-RNTI), and attempt the initial access again. Second, if one Msg3 is successfully received, the base station may copy the first 48 bits of the information transmitted in the Msg3, and transmit a Msg4 including them to the terminal. Among terminals that successfully receive the Msg4, a terminal that determines that the information in the Msg4 matches information in the Msg3 transmitted by the terminal changes its TC-RNTI to a C-RNTI and considers that the initial access has succeeded. A terminal that determines that the information in the Msg4 does not match information in the Msg3 transmitted by the terminal considers the initial access to have failed and attempts the initial access again after a backoff. For example, a repeated transmission operation for a case where a parameter msg4-NumberofRepetitions is provided in the SIB1 may be defined by extending a reception procedure for a PDSCH for DCI format 1_0 scrambled by the TC-RNTI.

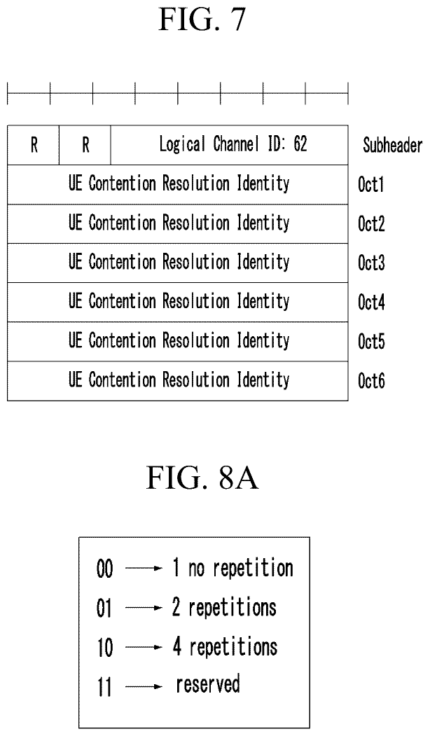

Hereinafter, with reference to FIG. 7, the detailed structure of the Msg4 (contention resolution) and problems that may occur when the Msg4 is not successfully received due to a poor channel condition will be described.

FIG. 7 is a diagram illustrating a structure of a downlink common control channel (DL CCCH) protocol data unit (PDU) of Msg4.

Referring to FIG. 7, the current 3GPP NR specifications do not support repeated transmission of Msg4 to improve a reception signal quality of Msg4. Therefore, a method for improving the reception signal quality of Msg4 is required.

Meanwhile, in the existing 3GPP specifications, when a terminal applies an initial access standard in an environment with high loss or very low reception signal-to-noise ratio (SNR), such as a non-terrestrial network (NTN) channel, there may be a problem that a specific physical channel fails to achieve a required coverage due to insufficient link budget, and improvements for such physical channels are being discussed. In this regard, the communication network disclosed in the present disclosure applies a scheme for improving downlink coverage in a wireless communication system with a poor channel condition or high loss. For example, in a satellite communication system in which a transmission power is limited due to a power flux density (PFD) constraint on the ground caused by interference problems, there is a high possibility that the terminal fails to meet the required reception power for coverage, and such environments may require the performance enhancement. In particular, the scheme may be used as a means to expand the coverage of a downlink signal transmitted by the base station when the terminal has not yet established a connection with the base station.

Among the downlink signals transmitted by the base station, when the terminal is not yet connected to the base station, signals such as Msg2 or Msg4, which are transmitted during initial access, are limited in terms of time/frequency resources and number of transmissions. Therefore, in a wireless communication system with poor channel condition or high loss, the terminal may fail to properly receive such signals. Thus, a downlink repeated transmission scheme is required to overcome this.

More specifically, exemplary embodiments associated with the communication network disclosed herein may relate to a repeated transmission scheme applied to Msg4 among the signals transmitted by the base station to the terminal when the terminal and the base station are not yet connected. In other words, the exemplary embodiments of the present disclosure may relate to signaling methods of the base station in a process of applying repeated transmission for enhancing Msg4 coverage and to an operation of the terminal receiving the signaling.

Hereinafter, as a signaling method for repeated Msg4 transmission, a signaling scheme for the number of repeated transmissions (i.e. repetition factor) or a configuration of the number of repeated transmissions will be described.

The terminal may receive repeated transmission configuration information for Msg4 from the base station. In other words, the base station may transmit the repeated transmission configuration information for Msg4 to the terminal.

In this case, the repeated transmission configuration information may include information on supported repetition factors. However, the scope is not limited thereto, and in the description of exemplary embodiments of the present disclosure, the repeated transmission configuration information may broadly include, depending on an implementation of the present disclosure: an information element indicating enable or disable of repeated transmission; an information element indicating a target signal of repeated transmission; an information element indicating a target channel of repeated transmission; an information element indicating a set of supported repetition factors; an information element indicating a repetition factor; an information element indicating a periodicity of repeated transmission; an information element indicating a quality threshold used to determine whether to perform repeated transmission; an information element indicating a transmission resource for a message requesting repeated transmission; an information element indicating enable or disable of a transmission operation of the message requesting repeated transmission; an information element indicating a transmission resource for a message indicating feasibility of repeated transmission; and/or an information element indicating enable or disable of a transmission operation of the message indicating feasibility of repeated transmission.

Meanwhile, according to an exemplary embodiment of the present disclosure, the repetition factor included in the repeated transmission configuration information may itself be utilized as an activation element for repeated Msg4 transmission. In such a scheme, without a separate activation/deactivation indicator, the repetition factor may simultaneously indicate whether repeated transmission is to be performed and a specific number of repetitions. Specifically, when the repetition factor is set to 1, it may be interpreted that repeated transmission is deactivated, and a conventional single transmission scheme may be applied. When the repetition factor is set to a value equal to or greater than 2 (e.g. 2, 4, 8, etc.), it may be interpreted that repeated transmission is activated, and repeated transmission may be performed according to the repetition factor. This approach may provide an intuitive control mechanism while minimizing signaling overhead, and an activation state and specific degree of repeated transmission may be simultaneously controlled through a single parameter, thereby improving system implementation efficiency.

In this regard, the repeated transmission configuration information may be transmitted from the base station to the terminal through system information (SI). Specifically, according to an exemplary embodiment of the present disclosure, the base station may deliver the repetition factor through SIB1, SIB19, or SI, without being limited thereto. In another example, the repeated transmission configuration information may be received through a DCI. For example, the DCI may be a scheduling DCI for Msg4.

More specifically, the base station may introduce a field indicating a repetition factor in SIB1, SIB19, SI, DCI, or the like (e.g. in the case of SIB19, a field such as numberOfMsg4-RepetitionsList-r19), and may indicate a repetition factor by selecting one value from a sequence (e.g. a sequence of size n) available for the field.

For example, a sequence of length 4 such as {1, 2, 4, 8}, {1, 2, 3, 4}, or any other set of integers may be applied. When each element of the sequence is defined as representing one, two, four, or eight repetitions, respectively, and the field value is given as numberOfMsg4-RepetitionsList-r19==2, it may mean that all terminals requiring repeated Msg4 transmission within a cell are to perform repeated transmission two times. In this case, terminals that do not require or do not support the repeated transmission function may be configured not to perform repeated transmission.

In other words, the terminal may receive, from the base station, an information element indicating a set of supported repetition factors, and may further receive an information element indicating one of the supported repetition factors from the base station.

In this case, a set of supported repetition factors according to an exemplary embodiment of the present disclosure may alternatively be referred to as an ‘aggregation factor’ for repeated Msg4 transmission. For example, such an aggregation factor may be configured through SIB1, and the supported values may include 2 or 4. The communication network may configure a single value selected from 2 and 4 at a given time, and when the aggregation factor is configured in SIB1, it may be interpreted that repeated Msg4 transmission is activated. Through such a configuration scheme, a consistent repeated transmission policy may be applied to all terminals within a cell, and effective coverage enhancement may be achieved while minimizing system complexity.

Meanwhile, the sequence including the repetition factors may include {1} as an element, or may not include it depending on an implementation of the present disclosure. When {1} is included in the sequence, selection of the value 1 (e.g. numberOfMsg4-RepetitionsList-r19-=1) may be used to indicate that repeated Msg4 transmission is deactivated, according to an implementation of the present disclosure. Alternatively, when the sequence does not include {1}, a notation such as numberOfMsg4-RepetitionsList-r19==null (or [ ]) may be used to indicate the deactivation of repeated Msg4 transmission.

For example, the above-described scheme of operating the sequence may be represented as “numberOfMsg4-RepetitionsList-r19 SEQUENCE (SIZE 1 . . . 4) OF NumberOfMsg4-Repetitions-r19, where NumberOfMsg4-Repetitions-r19::=ENUMERATED {n1, n2, n4, n8}”.

In another example, the base station may fix the repetition factors supported in the specifications without separately introducing the numberOfMsg4-RepetitionsList-r19 field. For example, a fixed repetition factor (e.g. 2 or a natural number n equal to or greater than 3) may be predetermined for all terminals requiring repeated Msg4 transmission, and all terminals requiring repeated Msg4 transmission within the cell may perform repeated transmission according to the fixed value.

According to an exemplary embodiment of the present disclosure, the base station may introduce a field for indicating activation or deactivation of repeated Msg4 transmission through system information (e.g. SIB1, SIB19, SI, etc.). For example, Msg4-Repetitions-r19==1 may be a field configuration indicating that repeated Msg4 transmission is activated, and Msg4-Repetitions-r19==0 may be a field configuration indicating deactivation, without being limited thereto.

In another example, a plurality of fixed repetition factors may be preconfigured. For example, the supported repetition factors may be predetermined to be 2 or 4. In this case, the base station may represent the activation or deactivation of repeated Msg4 transmission through system information as follows. NumberOfMsg4-Repetitions-r19==2 (or 4) may be a field configuration indicating that two-time (or four-time) repeated Msg4 transmission is activated, and NumberOfMsg4-Repetitions-r19==0 may be a field configuration indicating deactivation. Additionally, the absence of the NumberOfMsg4-Repetitions-r19 field itself may be used to indicate deactivation of repeated transmission.

In this regard, according to a first exemplary embodiment of the present disclosure, the repeated transmission configuration information may include information on a repetition factor commonly applied to a plurality of terminals associated with a cell corresponding to the base station.

According to such cell-common repetition factor configuration signaling, the base station may configure all terminals requiring repeated Msg4 transmission within the cell to perform the same number of repeated transmissions.

Meanwhile, according to a second exemplary embodiment of the present disclosure, the repeated transmission configuration information may include information on a repetition factor dynamically allocated for each of the plurality of terminals.

According to such terminal-specific dynamic repetition factor configuration signaling, the base station may provide a function of dynamically changing the repetition factor for each terminal requiring repeated Msg4 transmission within in the cell. For example, in relation to the numberOfMsg4-RepetitionsList-r19 field described above, when a sequence including n elements is defined as {1, 2, 4, 8}, the base station may perform signaling in the form of numberOfMsg4-RepetitionsList-r19=={1, 2, 4, 8}, and dynamically allocate the repetition factor for repeated Msg4 transmission to be actually performed by each terminal and deliver it to each terminal. For example, the base station may inform each of the plurality of terminals of the applicable dynamic repetition factor using a DCI.

The above example may be represented as “numberOfMsg4-RepetitionsList-r19 SEQUENCE (SIZE 1 . . . 4) OF NumberOfMsg4-Repetitions-r19, where NumberOfMsg4-Repetitions-r19::=ENUMERATED {n1, n2, n4, n8}”.

Meanwhile, the scheme of dynamically allocating terminal-specific repetition factor disclosed in the present disclosure may include signaling for indicating activation or deactivation of repeated Msg4 transmission. For example, terminal-specific repeated Msg4 transmission activation may be indicated through DCI Format 1_0, and in this case, a reinterpretation scheme of the most significant bit (MSB) of an MCS field in the DCI may be used as a signaling means. Specifically, when the base station intends to dynamically activate repeated Msg4 transmission for a specific terminal, the base station may indicate the activation of repeated transmission by setting the MSB of the MCS field in DCI Format 1_0 transmitted to the corresponding terminal to ‘1’. The single transmission scheme may be applied when the MSB is set to ‘0’, and repeated transmission may be deactivated. Through such a dynamic signaling scheme, the base station may control repeated transmission in real time according to each terminal's channel condition and service requirements. This may provide terminal-specific customized optimization functionality that is distinguished from the cell-common repeated transmission scheme described above.

In other words, according to an implementation of the present disclosure, dynamic allocation of the repetition factor per terminal may be indicated using a DCI for scheduling the Msg4, and the DCI for scheduling the Msg4 may be configured as shown in Table 4 below, and some of the fields in the table may be reused for the purpose of delivering the repetition factor of Msg4.

TABLE 4

| Field (Item) | Bits | Reference |
|---|---|---|
| Identifier for DCI formats | 1 | Always set to 1, meaning this is for DL |
| Frequency domain resource | Variable | Variable with DL BWP N_RB |
| assignment | | $⌈ {log}_{2} ( {N}_{RB}^{DL , BWP} ( {N}_{RB}^{DL , BWP} + 1 ) / 2 ) ⌉$ |
| | | ${N}_{RB}^{DL , BWP} indicates the size of CORESET 0$ |
| Time domain resource | 4 | Carries the row index of the items in |
| assignment | | pdsch_allocationList in RRC |
| VRB-to-PRB mapping | 1 | According to 38.212 Table 7.3.1.1.2-33, |
| | | 0: Non-Interleaved |
| | | 1: Interleaved |
| Modulation and coding | 5 | 38.214 - Table 5.1.3.1-1: MCS index table 1 for |
| scheme | | PDSCH |
| | | 38.214 - Table 5.1.3.1-2: MCS index table 2 for |
| | | PDSCH |
| New data indicator | 1 | |
| Redundancy version | 2 | |
| HARQ process number | 4 | |
| Downlink assignment index | 2 | Reserved |
| TPC command for | 2 | |
| scheduled PUCCH | | |
| PUCCH resource indicator | 3 | |
| PDSCH-to- | 3 | Row number (index) of K1 |
| HARQ_feedback timing | | |
| indicator | | |

Specifically, Table 4 refers to DCI_1_0 scrambled by a TC_RNTI for notifying resource allocation information of Msg4. In this regard, the base station may reuse or reinterpret at least some bits of a field such as a modulation and coding scheme (MCS) field, HARQ process number (HPN) field, HARQ field, and downlink assignment index (DAI) field to deliver information related to the number of Msg4 repetitions. According to an exemplary embodiment of the present disclosure, a reinterpretation scheme of the MSB of the MCS field in DCI Format 1_0 may be applied as a specific signaling scheme for indicating repeated Msg4 transmission. In this scheme, when the terminal confirms that the msg4-NumberofRepetitions parameter is configured through SIB1 and reports a repeated Msg4 transmission capability through the Msg3 PUSCH, if the MSB value in the MCS field of DCI Format 1_0 is set to ‘l’, the terminal may perform repeated transmission according to the configured msg4-NumberofRepetitions. Conversely, if the MSB value is ‘0’, a conventional single transmission scheme may be applied. This scheme may enable effective control of repeated transmission while minimizing changes to the existing DCI structure.

According to an exemplary embodiment of the present disclosure, frequency hopping may be applied in repeated Msg4 transmission, and guidance information related to the frequency hopping may be delivered to the terminal through reuse of the DCI. The terminal, having read the DCI after Msg3 transmission, may confirm how many times Msg4 corresponding to the Msg3 is to be repeatedly transmitted.

In another example, a new field indicating the repetition factor may be added to the DCI, or reserved bits may be used.

In another example, the TDRA field or another field, TB scaling bits, or a new RNTI may be used. According to an implementation of the present disclosure, a method of combining and reinterpreting bits from multiple fields may also be applied.

More specifically, when the base station configures and transmits the Msg4 repetition factor dynamically allocated per terminal using a DCI, if a sequence of numberOfMsg4-RepetitionsList-r19 is {1, 2, 4, 8}, two bits in the DCI may be used to dynamically indicate the actual repetition factor. For example, if the field value used for setting the Msg4 repetition factor in the DCI is 00, 01, 10, or 11, these values may be mapped respectively to one-time, two-time, four-time, and eight-time repeated transmissions, without being limited thereto.

Additionally, the scheme of dynamically allocating the Msg4 repetition factor per terminal using a DCI may be applied to a DCI of the RAR. In other words, according to an implementation of the present disclosure, a scheme of utilizing at least a part of the DCI field indicating a resource of the Msg2, or a scheme of indicating the repetition factor within data may be considered.

In another example, as a signaling scheme for the Msg4 repetition factor per terminal, a scheme of implicitly delivering the information using a scaling factor of Msg2 may be applied. A scheme of directly delivering the information through Msg2 may also be considered.

For example, a new field may be added to the grant field of the Msg2 RAR, or an existing field may be reused or reinterpreted. Additionally, the repeated transmission configuration information may be delivered in association with the existing grant field value of the Msg2 RAR. For instance, a scheme of implicitly delivering the information using an MCS level of the grant field or delivering it in association with the MCS level may be considered.

In another example, as a signaling scheme for repeated transmission, a scheme of preconfiguring a repetition factor commonly applied to a cell associated with the base station, and allocating (indicating) whether to perform repeated transmission to each terminal in the cell may be applied. To aid in understanding, for example, if the fixed repetition factor commonly applied to the cell is preconfigured to two, a field value may be set as numberOfMsg4-RepetitionsList-r19==2, thereby enabling repeated transmission support and setting the repetition factor for the cell, and furthermore, a portion of the bits of DCI_1_0 scrambled by TC_RNTI may be reused to deliver information regarding whether each terminal performs repeated Msg4 transmission.

Hereinafter, a signaling scheme for repeated Msg4 transmission, particularly a signaling scheme for repeated transmission conditions will be described.

According to an exemplary embodiment of the present disclosure, the repeated transmission configuration information may include a quality threshold for determining whether repeated Msg4 transmission is required. In this case, the quality threshold used to determine whether repeated Msg4 transmission is to be performed may be distinguished from a quality threshold used to determine whether repeated transmission is to be performed for other messages such as Msg3 transmitted and received during the RA procedure. For example, types, calculation schemes, and values of the quality thresholds configured for different messages may differ from each other.

Additionally, the terminal may determine whether to apply repeated transmission (repeated reception) using the received quality threshold. Specifically, when a quality evaluation value measured by the terminal is lower than the quality threshold, the terminal may operate to apply repeated reception for Msg4.

In this regard, according to an exemplary embodiment of the present disclosure, in repeated Msg4 transmission, the base station may configure signaling information regarding the repeated transmission condition of Msg4 such that the terminal may evaluate whether repeated Msg4 transmission is required, and transmit the information as repeated transmission configuration information to the terminal. For example, the base station may apply an RSRP-based quality threshold and may introduce a parameter rsrp-ThresholdMsg4-r19 for this purpose. For example, the base station may configure and transmit rsrp-ThresholdMsg4-r19 through system information (e.g., SIB1, SIB19, SI, etc.). Meanwhile, a new parameter may be introduced or an existing parameter may be reused to signal information regarding the quality threshold.

For example, when the RSRP measured by the terminal is smaller than the value of rsrp-ThresholdMsg4-r19 delivered as the quality threshold, the corresponding terminal may be a terminal requiring repeated Msg4 transmission. Accordingly, when the measured RSRP is smaller than the value of rsrp-ThresholdMsg4-r19, the terminal may perform repeated Msg4 reception.

More specifically, when the RSRP measured at the terminal is lower than the quality threshold rsrp-ThresholdMsg4-r19, and a predetermined repetition factor is commonly configured by the base station for a cell corresponding to the terminal, the terminal may assume that Msg4 is repeatedly transmitted according to the repetition factor. In this case, the terminal may receive all Msg4 transmissions repeated according to the repetition factor, or, according to an implementation of the present disclosure, may selectively receive only a portion of the repeated Msg4 transmissions.

Additionally, when the repetition factor is configured as cell-common, the terminal may operate to receive at least a portion of the repeated Msg4 transmissions even if the RSRP measured (evaluated) at the terminal is greater than the quality threshold rsrp-ThresholdMsg4-r19.

Meanwhile, the value of rsrp-ThresholdMsg4-r19, which indicates the repeated transmission condition for Msg4, may be a value related to a reception power associated with at least one of Msg2, SSB, SIB1, SIB19, and SI measured at the terminal. For example, the value may correspond to the reception power of each of Msg2, SSB, SIB1, SIB19, and SI, or to an average reception power of at least one among Msg2, SSB, SIB1, SIB19, and SI.

According to an exemplary embodiment of the present disclosure, the terminal may measure (evaluate) a signal quality such as RSRP from a signal transmitted by the base station prior to transmission and reception of Msg1, determine in advance whether reception of Msg4 through repeated transmission is required, and transmit the corresponding information to the base station through Msg1. A portion of the DCI field indicating a resource of the Msg2 may be utilized, or the repetition factor may be indicated within data.

Hereinafter, signaling scheme applicable for cases in which the terminal determines that repeated transmission is required and requests repeated transmission to the base station or informs the base station that the terminal supports repeated transmission, and signaling transmission channels therefor will be described.

According to an exemplary embodiment of the present disclosure, the terminal may transmit to the base station at least one of a request indicating that repeated Msg4 transmission is required and report information on the terminal's repeated reception capability.

In other words, when necessary, the terminal may request repeated Msg4 transmission to the base station or report that the terminal has repeated reception capability through the following schemes.

For example, a scheme may be applied in which the base station and the terminal share a predefined table for RSRP ranges and the terminal feeds back an index (i.e. RSRP range index) of a range to which the measured RSRP belongs to the base station.

In another example, the terminal may feed back the RSRP value itself. In yet another example, the base station may determine whether repeated transmission is required for the terminal by measuring (evaluating) an uplink communication quality of Msg1 or Msg3 transmitted from the terminal.

The following describes signaling transmission channels usable for requesting repetitions or reporting repeated transmission capability to the base station. For example, a terminal supporting repeated Msg4 transmission may report the corresponding capability to the base station through Msg3.

Meanwhile, in the description of exemplary embodiments of the present disclosure, capability reporting and request operations may refer to substantially the same process. Accordingly, according to an implementation of the present disclosure, reporting of the terminal's repeated reception capability and requesting repeated transmission based on the need may be processed through the same signaling mechanism. In particular, applying specific conditions for capability reporting (e.g. when the measured RSRP is lower than a certain threshold) may be understood as a measure to improve system efficiency and avoid unnecessary signaling overhead.

For example, during the RA procedure, the terminal may transmit to the base station at least one of the request and the report on repeated transmission reception capability using Msg3, without being limited thereto.

Specifically, according to an exemplary embodiment of the present disclosure, when transmitting Msg3 to the base station, the terminal may transmit a MAC CE including at least one of the request and the report on repeated reception capability. In other words, the terminal may use a MAC CE for Msg3 to transmit the request or report.

In another example, when transmitting Msg1, the terminal may transmit at least one of the request and the report based on a RACH occasion (RO). In other words, the terminal may use a partitioned RO channel allocated as a request/repetition indication for the transmission of the request or report.

The following describes an exemplary embodiment in which additional signaling for repeated Msg4 transmission is omitted, and repeated Msg4 transmission is performed using information associated with repeated transmission of other downlink channels.

In other words, according to an implementation of the present disclosure, the repeated reception operation of Msg4 from the base station at the terminal may be performed in consideration of at least one of whether repeated transmission is applied to a predetermined downlink channel and a repetition factor for the predetermined downlink channel.

Specifically, as an implementation related to repeated Msg4 transmission and signaling therefor, signaling for repeated Msg4 transmission may be performed in association with information on whether repeated transmission is applied to a specific downlink channel from the base station to the terminal and/or the repetition factor for the specific downlink channel.

For example, signaling for repeated Msg4 transmission may be performed based on whether Msg2 is transmitted repeatedly and/or the repetition factor therefor, and Msg4 may be transmitted and received through repeated transmission. In this case, transmission of the request for repeated Msg4 transmission or the report on repeated reception capability at the terminal may be omitted, although not limited thereto. According to another implementation of the present disclosure, even when referring to information on repeated transmission configuration applied to another downlink channel, transmission of the request for repeated Msg4 transmission or the report on repeated reception capability as described above may still be performed.

In another example, signaling for repeated Msg4 transmission may be performed based on whether repeated transmission is applied to system information such as SIB1 or SIB19 and/or the repetition factor therefor, and Msg4 may be transmitted and received through repeated transmission.

The following comprehensively describes the overall process (procedure) for repeated Msg4 transmission and repeated Msg4 reception in the communication network according to the present disclosure, as described in detail above.

Under a poor channel condition (e.g. in an NTN environment), the base station may expect that all terminals within coverage experience relatively large SNR loss, and considering this, may improve the reception SNR of the terminals by repeatedly transmitting signals to the terminals present within the cell. The following scheme may be applied for cell-common repeated transmission for that purpose.

First, the base station may fixedly allocate repeated transmission configuration information in information initially acquired by the terminal for initial access, such as SIB1 or SIB19. For example, for an NTN terminal, such repeated transmission configuration may be configured as an RRC parameters in SIB19.

Meanwhile, when multiple terminals are located within coverage, terminals in the NTN cell may have significantly different distances from the base station depending on their positions, and signal attenuation and loss may also differ. Therefore, an option to configure a different repetition factor for a downlink signal such as Msg4 per terminal may be considered, and a signaling scheme for indicating repeated Msg4 transmission per terminal may be performed as follows.

First, the terminal may measure a strength of a signal transmitted by the base station, determine whether repeated transmission is required, and deliver the corresponding intent to the base station.

For example, the terminal may measure an RSRP of an SSB received prior to Msg1 transmission, compare the measured RSRP with a quality threshold value delivered from the base station or preconfigured, and determine whether repeated Msg4 transmission is required, and may inform the result to the base station implicitly or explicitly.

In another example, the terminal may measure an RSRP of a signal of Msg2 RAR received before Msg3 transmission, compare the measured RSRP with a quality threshold value delivered from the base station or preconfigured, determine whether repeated Msg4 transmission is required, and inform the result to the base station implicitly or explicitly.

In another example, the terminal may apply a scheme of combining quality evaluation results for multiple signals including SSB signals and Msg2 RAR signals (e.g. SNR combining) to measure an RSRP value, and compare the result with the delivered or configured threshold.

According to another exemplary embodiment of the present disclosure, the base station may measure signals such as Msg1 and Msg3 transmitted by the terminal and, based on the measured information, recognize the channel quality with the terminal. Each signal quality of Msg1 and Msg3 may be used independently or may be combined (e.g. through combining techniques) to determine whether repeated transmission is required for the terminal, and the base station may inform the terminal that repeated transmission is required.

Meanwhile, regarding a scheme in which the terminal implicitly or explicitly informs the base station that repeated transmission is required, the base station may, for example, configure a portion of ROs separately for terminals requiring repeated Msg4 transmission. Through this, the terminal may implicitly inform that repeated Msg4 transmission is required by using the RO for Msg4 repetition preconfigured by the base station.

In another example, the terminal may use a part of higher-layer signaling such as MAC CE or a portion of a data signal during Msg3 transmission to indicate that repeated Msg4 transmission is required. When the base station receives such a request for repeated transmission or a report of repeated Msg4 reception capability from the terminal, the base station may transmit information on a specific repetition factor through DCI that schedules Msg4.

Meanwhile, the DCI scheduling Msg4 may be configured as shown in Table 4 described above, and at least some of the fields in the DCI may be reused to allocate information on the repetition factor for Msg4.

Specifically, regarding DCI_1_0 scrambled by TC_RNTI for indicating resource allocation information of Msg4, bits such as MCS, HARQ, and DAI may be reused to allocate the repetition factor for Msg4. Additionally, in consideration of the application of frequency hopping to repeated Msg4 transmission, such information may be delivered through reuse of the DCI.

Specifically, after transmitting Msg3, the terminal obtaining the DCI may confirm how many times Msg4 corresponding to the Msg3 is subsequently received as repeated transmission.

For example, if 2 bits are used (reused) to indicate the repetition factor, each combination of 2 bits, i.e., 00, 01, 10, and 11, may be mapped to 1, 2, 4, and 8 repetitions, respectively. In the case where repeated Msg4 transmission is performed, signal overlapping may be used to improve SNR.

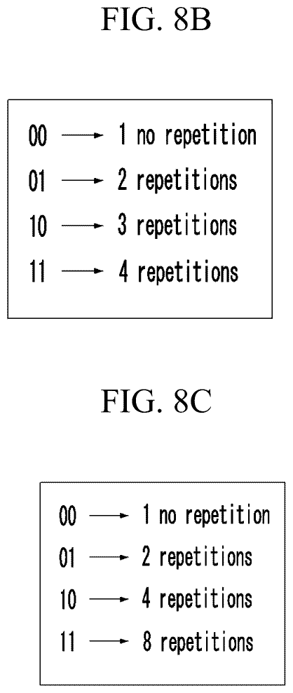

In this regard, FIGS. 8A to 8C are conceptual diagrams for illustratively describing a method of indicating a Msg4 repetition factor using DCI field(s).

Referring to FIG. 8A, in a method of indicating a repetition factor using a 2-bit field in the DCI, 00 may correspond to no repetition, 01 to 2 repetitions, 10 to 4 repetitions, and 11 to reserved. Also, referring to FIG. 8B, in the same 2-bit field, 00 may correspond to no repetition, 01 to 2 repetitions, 10 to 3 repetitions, and 11 to 4 repetitions. Also, referring to FIG. 8C, 00 may correspond to no repetition, 01 to 2 repetitions, 10 to 4 repetitions, and 11 to 8 repetitions. As such, according to an implementation of the present disclosure, different repetition factor mapping schemes may be selectively applied depending on system requirements and channel conditions, thereby providing optimized performance in various wireless communication environments.

According to an exemplary embodiment of the present disclosure, the terminal may refer to a DCI of the RAR to identify information on the Msg4 repetition factor. In this case, the terminal may measure an RSRP value from a signal transmitted by the base station prior to Msg1 and request or inform the base station via Msg1 that Msg4 needs to be received through repeated transmission. A portion of the DCI field indicating a resource of the Msg2 may be utilized to indicate the repetition factor, or the repetition factor may be indicated within data.

Meanwhile, when repeated Msg4 transmission is performed, the base station may configure a time interval between Msg4 repetitions. For example, the time interval between repetitions may be configured in slot units, although not limited thereto. According to an implementation of the present disclosure, the time interval between repetitions may also be configured in symbol units or in units of multiple symbols. According to an implementation of the present disclosure, the time interval for repeated Msg4 transmission may be applied as a fixed value predetermined by the specifications.

According to an exemplary embodiment of the present disclosure, information on the time interval applied to repeated transmission may be delivered through system information such as SIB1, SIB19, or SI, although not limited thereto.

In this regard, according to an exemplary embodiment of the present disclosure, the time interval applied to repeated Msg4 transmission may be determined comprehensively considering the channel environment of the communication network, terminal mobility, and system resource efficiency. For example, in a channel with large propagation delay such as an NTN environment, a relatively short time interval may be applied to maintain channel coherence, while in a stable channel environment, a longer time interval may be applied for efficient use of system resources. In another example, when the terminal has high mobility, repeated transmission may be performed in consecutive slots to cope with fast channel variation, whereas for a terminal in a stationary state or moving at low speed, repeated transmission may be performed at regular intervals. In another example, the base station may dynamically adjust the time interval in consideration of cell traffic load and resource sharing with other terminals, and information on such time interval may be delivered to the terminal through the system information as described above.

According to an exemplary embodiment of the present disclosure, the terminal may perform repeated Msg4 reception based on the acquired repeated transmission configuration information. In this case, the terminal may receive Msg4 in consecutive slots with the same resource allocation, and Msg4 with different redundancy versions (RVs) or with at least some identical RVs may be received for the respective repetitions.

Specifically, when the terminal performs repeated Msg4 reception in consecutive slots, an RV cycling scheme applied to the respective repetitions may follow the RV cycling pattern defined in the 3GPP specifications. For example, when pdsch-msg4AggregationFactor is configured, a method for applying the same symbol allocation and RV cycling in consecutive slots may be specified.

For example, when the repetition factor is 4, a different RV cycling pattern may be applied depending on a starting RV. When the starting RV is 0, RVs 0, 2, 3, and 1 may be applied sequentially for n mod 4=0, 1, 2, 3. When the starting RV is 2, RVs 2, 3, 1, and 0 may be applied in order. In another example, when the starting RV is 3, RVs 3, 1, 0, and 2 may be applied. When the starting RV is 1, RVs 1, 0, 2, and 3 may be applied sequentially. Through such RV cycling, different encoded bits may be transmitted in each repetition, thereby achieving a diversity effect. The terminal may combine them to improve decoding performance.

A signal transmission technique for improving a link budget in downlink transmission, according to an exemplary embodiment of the present disclosure, may be implemented in the form of program instructions that can be executed through various computer means and may be recorded on a computer-readable medium. The computer-readable medium may include, alone or in combination, program instructions, data files, data structures, and the like. The program instructions recorded on the medium may be specially designed and configured for the present disclosure or may be known and available to those skilled in computer software. Examples of computer-readable recording media include magnetic media such as hard disks, floppy disks, and magnetic tapes; optical media such as CD-ROMs and DVDs; magneto-optical media such as floptical disks; and hardware devices specially configured to store and execute program instructions, such as ROM, RAM, and flash memory. Examples of the program instructions include machine code generated by a compiler as well as high-level language code executable by a computer using an interpreter or the like. The above-described hardware devices may be configured to operate as one or more software modules to perform the operations of the present disclosure, and vice versa.

Furthermore, the above-described signal transmission technique for improving a link budget in downlink transmission may also be implemented in the form of a computer program or application executed by a computer and stored in a recording medium.

The foregoing description of the present disclosure is intended for illustrative purposes only, and those skilled in the art to which the present disclosure pertains will understand that various modifications can be made without departing from the technical spirit or essential features of the present disclosure. Therefore, the above-described exemplary embodiments should be understood as illustrative and not limiting in every respect. For example, each component described as being implemented in a singular form may be implemented in a distributed manner, and similarly, components described as being distributed may be implemented in a combined form.

The scope of the present disclosure is defined by the following claims rather than the foregoing detailed description, and all modifications or variations derived from the meanings and scope of the claims and their equivalents are to be interpreted as being included within the scope of the present disclosure.

What is claimed is:

1. A method of a terminal, comprising:
receiving repeated transmission configuration information for a message 4 (Msg4) from a base station; and
receiving the Msg4 from the base station in a random access (RA) procedure between the terminal and the base station, the receiving comprising performing repeated reception of the Msg4 based on the repeated transmission configuration information.

2. The method according to claim 1, wherein the repeated transmission configuration information includes at least one of: information on a repetition factor commonly applied to a plurality of terminals associated with a cell corresponding to the base station, or information on a repetition factor dynamically allocated for each of the plurality of terminals.

3. The method according to claim 1, further comprising transmitting, to the base station, at least one of: a request indicating that repeated transmission of the Msg4 is required, or information on a repeated reception capability of the terminal.

4. The method according to claim 3, wherein the transmitting comprises transmitting at least one of the request or the information on the repeated reception capability using a Msg3.

5. The method according to claim 3, wherein the transmitting comprises selecting a random access channel (RACH) occasion (RO) for transmitting at least one of the request or the information on the repeated reception capability in Msg1 transmission.

6. The method according to claim 1, wherein the receiving of the repeated transmission configuration information comprises receiving the repeated transmission configuration information including information on repetition factor(s) through system information (SI).

7. The method according to claim 1, wherein the repeated transmission configuration information includes a quality threshold for determining whether repeated transmission of the Msg4 is required.

8. The method according to claim 7, wherein the performing of the repeated reception comprises applying the repeated reception of the Msg4, when a quality evaluation value measured at the terminal is lower than the quality threshold.

9. The method according to claim 1, wherein the repeated transmission configuration information includes information on supported repetition factors, and information on a repetition factor among the supported repetition factors is indicated in a field of downlink control information (DCI).

10. The method according to claim 1, wherein the repeated transmission configuration information includes information on supported repetition factors, and the supported repetition factors includes 2 or 4.

11. The method according to claim 1, wherein the performing of the repeated reception of the Msg4 comprises: receiving the Msg4 in a plurality of consecutive slots with a same resource allocation, different redundancy versions (RVs) or RVs that are at least partially identical being applied to repetitions of the Msg4.

12. A method of a base station, comprising:
transmitting repeated transmission configuration information for a message4 (Msg4) to a terminal; and
transmitting the Msg4 to the terminal in a random access (RA) procedure between the terminal and the base station, the transmitting comprising performing repeated transmission of the Msg4 based on the repeated transmission configuration information.

13. The method of claim 12, wherein the repeated transmission configuration information includes at least one of: information on a repetition factor commonly applied to a plurality of terminals associated with a cell corresponding to the base station, or information on a repetition factor dynamically allocated for each of the plurality of terminals.

14. The method of claim 12, further comprising receiving, from the terminal, at least one of: a request indicating that repeated transmission of the Msg4 is required, or information on a repeated reception capability of the terminal.

15. The method of claim 14, wherein the receiving comprises receiving at least one of the request or the information on the repeated reception capability using a Msg3.

16. The method of claim 14, wherein the receiving comprises receiving the at least one of the request or the information on the repeated reception capability through a random access channel (RACH) occasion (RO) selected for transmission of the at least one of the request or the information on the repeated reception capability.

17. A terminal comprising at least one processor, wherein the at least one processor causes the terminal to perform:
receiving repeated transmission configuration information for a message 4 (Msg4) from a base station; and
receiving the Msg4 from the base station in a random access (RA) procedure between the terminal and the base station, the receiving comprising performing repeated reception of the Msg4 based on the repeated transmission configuration information.

18. The terminal of claim 17, wherein the repeated transmission configuration information includes at least one of: information on a repetition factor commonly applied to a plurality of terminals associated with a cell corresponding to the base station, or information on a repetition factor dynamically allocated for each of the plurality of terminals.

19. The terminal of claim 17, wherein the at least one processor further causes the terminal to perform: transmitting, to the base station, at least one of: a request indicating that repeated transmission of the Msg4 is required, or information on a repeated reception capability of the terminal.

20. The terminal of claim 17, wherein the performing of the repeated reception of the Msg4, the at least one processor further causes the terminal to perform: receiving the Msg4 in a plurality of consecutive slots with a same resource allocation, different redundancy versions (RVs) or RVs that are at least partially identical being applied to repetitions of the Msg4.
